(19) United States
(12) Patent Application Publication
(10) Pub. No.: US 2011/0111274 A1
(43) Pub. Date: May 12, 2011

(54) Flooded Battery Vent Cap

(76) Inventor: Thomas Foushee, Winston-Salem, NC (US)

(21) Appl. No.: 12/614,315

(22) Filed: Nov. 6, 2009

(51) Int. Cl. H01M 2/12

(52) U.S. Cl. 429/89

(57) ABSTRACT

The present application is directed to embodiments of a flooded battery vent cap. The vent cap may include an internal vent well and an external mounting flange. The internal vent well may be comprised of a hollow cylindrical tube sized to accept a watering gun nozzle therein. The internal vent well may include a variety of elements that limit an insertion depth of the watering gun nozzle. In one embodiment, the internal vent well may comprise at least a first section and a second section.

### BACKGROUND

The present application is directed to vent caps for flooded batteries, and more particularly, to flooded battery vent caps that properly position a nozzle of a watering gun within the flooded battery for adding water to the flooded battery.

Traditional lead acid batteries work on the principle of a chemical reaction between a plurality of electrodes constructed of lead and lead dioxide immersed in an electrolyte solution. The electrolyte is typically a solution of sulfuric acid and water. The chemical reactions that occur between the electrodes (alternating anodes and cathodes) in the presence of the electrolyte produce an electric current.

One of the most common applications for lead acid batteries is the starting battery in automobiles and trucks. These batteries are designed to produce maximum current output for short durations to handle the heavy load of starting the vehicle engine. Another common application for lead acid batteries are those designed for deep cycle operation in which the batteries are routinely discharged and then recharged. Deep cycle batteries are particularly suited for fully or partially electrically powered vehicles including automobiles, forklifts, and golf carts; material handling systems; traffic management systems; off-grid power systems; and industrial cleaning equipment.

Flooded batteries require the addition of distilled water on a periodic basis depending on battery type, operating temperature, charge controller operation, and usage. Water may be lost through evaporation out of vent openings in the battery case, or through electrolysis of the water into hydrogen and oxygen. When replenishing lost water, enough water is added to just cover the electrodes. Overfilling the battery may lead to detrimental effects, particularly spillage of the corrosive electrolyte solution outside of the battery which may lead to damage of equipment or nearby objects.

A number of methods and devices have been devised to simplify the proper filling of flooded batteries. However, many industrial applications of flooded batteries require large numbers of individual batteries which complicates the filling process and makes it difficult to ensure that each and every battery cell is properly filled.

One type of battery filling device includes a system of tubing and specially constructed battery vent caps that distributes water to each battery cell. While this type of system has several advantages, the tubing and vent caps may be easily snagged and broken when removing and adding batteries or when operating and maintaining the equipment powered by the batteries.

Another commonly used device to add water to flooded batteries is a watering gun which includes a nozzle that is inserted into the battery through a vent opening. In particular, one type of watering gun includes an automatic shutoff feature that shuts off the flow of water when the water level reaches the proper level. While this device simplifies battery filling, the insertion depth of the watering gun nozzle into the battery vent opening is critical to proper operation.

### SUMMARY

The present application is directed to embodiments of a flooded battery vent cap. The vent cap may include an internal vent well and an external mounting flange. The internal vent well may be comprised of a hollow cylindrical tube sized to accept a watering gun nozzle therein. The internal vent well may include a variety of elements that limit an insertion depth of the watering gun nozzle. In one embodiment, the internal vent well may comprise at least a first section and a second section. The first and second sections may engage one another such that a variety of lengths of the internal vent well may be selected.

### BRIEF DESCRIPTION OF THE DRAWINGS

FIG. 1 is a perspective view of a flooded battery vent cap according to one embodiment.

FIG. 2 is a cut away view of a flooded battery with a flooded battery vent cap positioned in a vent opening according to one embodiment.

FIG. 3 is a schematic view of a flooded battery with a flooded battery vent cap positioned in a vent opening and a fill gun nozzle positioned in the vent cap according to one embodiment.

FIG. 4 is a side schematic view of a flooded battery vent cap with an adjustable length internal vent well according to one embodiment.

FIG. 5 is a side schematic view of a flooded battery vent cap with an adjustable length internal vent well according to one embodiment.

FIG. 6 is a top view of a flooded battery vent cap with an insertion depth limiter according to one embodiment.

FIG. 7 is a top view of a flooded battery vent cap with an insertion depth limiter according to one embodiment.

FIG. 8 is a top view of a flooded battery vent cap with an insertion depth limiter according to one embodiment.

FIG. 9 is a top view of a flooded battery vent cap with an insertion depth limiter according to one embodiment.

FIG. 10 is a side schematic view of a flooded battery vent cap with an insertion depth limiter according to one embodiment.

FIGS. 11A, 11B, and 11C are side schematic view of a flooded battery vent cap with an insertion depth limiter according to one embodiment.

FIG. 12 is a perspective view of a flooded battery vent cap and cover according to one embodiment.

FIG. 13 is a perspective view of a flooded battery vent cap and cover according to one embodiment.

FIG. 14 is a side view of a flooded battery vent cap and cover according to one embodiment.

FIG. 15 is a side schematic view of a flooded battery vent cover according to one embodiment.

FIG. 16 is a side schematic view of a flooded battery vent cover according to one embodiment.

### DETAILED DESCRIPTION

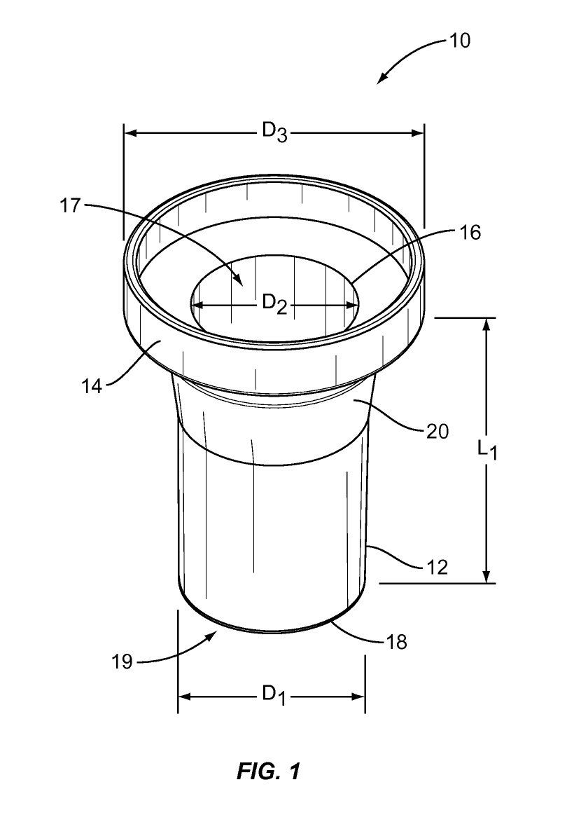

The present application is directed to embodiments of a flooded battery vent cap. As illustrated in FIG. 1, the vent cap 10 may include an internal vent well 12. The internal vent well may have an upper end 16 and a lower end 18, and a length L₁ measured from the upper end 16 to the lower end 18. An external mounting flange 14 may be attached to the upper end 16 of the internal vent well 12.

The internal vent well 12 has a first internal diameter D₁ in proximity to the lower end 18 defining a lower opening 19 and a second internal diameter D₂ in proximity to the upper end 16 defining an upper opening 17. In one embodiment, the first internal diameter D₁ and the second internal diameter D₂ are approximately the same. In other embodiments, the first internal diameter D₁ and the second internal diameter D₂ are different. The external mounting flange 14 has an outer diameter D₃. Typically, the outer diameter D₃ is larger than either the first or second internal diameters D₁, D₂. However, in at least some embodiments the outer diameter D₃ of the external mounting flange 16 is approximately the same as the second internal diameter D₂ of the internal vent well 12.

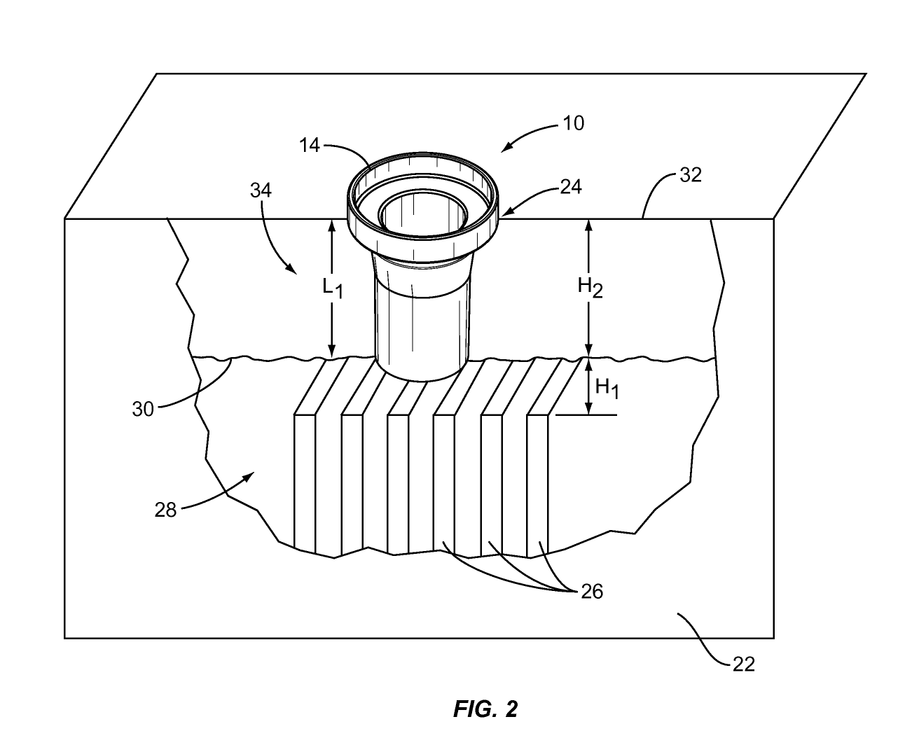

FIG. 2 illustrates one embodiment of the vent cap 10 positioned in a vent opening 24 of a flooded battery 22. The vent opening 24 is located on an upper surface 32 of the flooded battery 22. The flooded battery 22 is comprised of a plurality of electrodes 26 that are positioned internally within the flooded battery 22 and spaced a distance below the top surface of the flooded battery 22. The electrodes 26 are immersed in an electrolyte solution 28. Typically, the amount of electrolyte solution 28 in the flooded battery 22 is selected such that electrodes 26 are immersed in the electrolyte solution 28 by a predetermined distance H₁. In many applications, the distance H₁ is approximately ¼ to ½ inch. Other distances H₁ may also be used.

Flooded batteries 22 are typically designed such that there is a free space 34 between the proper fill level (or upper surface) 30 of the electrolyte solution 28 and the upper surface 32 of the flooded battery 22. Because the position of the electrodes 26 within the flooded battery 22 is fixed, as is the recommended height H₁ of the electrolyte solution 28 above the electrodes 26, a height H₂ of the free space 34 as measured from the upper surface 30 of the electrolyte solution 28 to the upper surface of the battery 32 is generally fixed for a given flooded battery 22. The free space 34 allows gas bubbles formed on the surface of the electrodes 26 to burst without splattering the electrolyte solution 28 out of the vent opening 24 during recharging of the flooded battery 22. The free space 34 also allows some movement of the electrolyte solution 28 within the flooded battery 22 when the flooded battery 22 is in motion, such as when a vehicle in which the flooded battery 22 is mounted is moving. Finally, the free space 34 allows a controlled buildup of pressure within the flooded battery 22 when gases are generated at the electrodes 26. For most typical applications, the distance H₂ is approximately ⅛ inch to approximately 1 inch below the upper surface 32 of the flooded battery 32.

Therefore, it is recognized by users of flooded batteries 22 that proper maintenance of the flooded batteries 22 is critical to proper and safe operation, including maintaining the proper amount of electrolyte solution 28. However, when adding water to a plurality of flooded batteries 22, it may be difficult for the user to see inside each vent opening 24 and determine the electrolyte solution level 30 within each flooded battery 22. This leads to operator error in which the flooded battery 22 may be overfilled or underfilled.

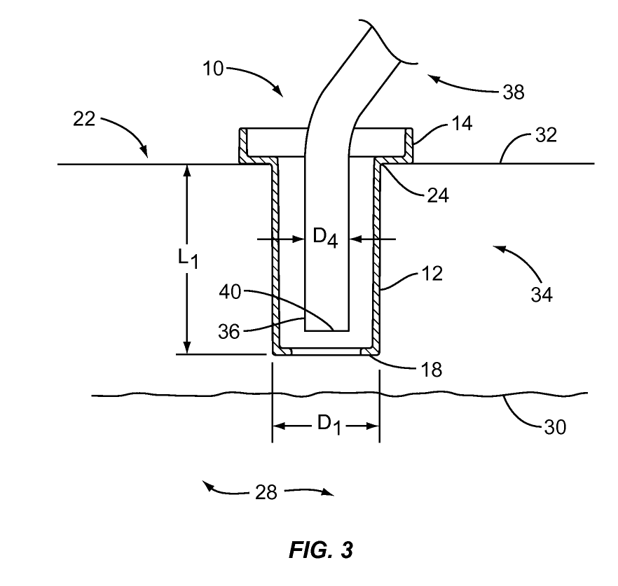

Embodiments of the present invention, particularly when used with a fill gun with an automatic shutoff, eliminate the operator error that may be associated with adding water to flooded batteries 22. As illustrated in FIG. 3, an embodiment of the vent cap 10 is positioned in the vent opening 24 in the upper surface 32 of the flooded battery 22. The internal vent well 12 extends a distance into the flooded battery 22 approximately equal to the length L₁ of the internal vent well 12. Thus, for a given flooded battery 22, the length L₁ is selected to approximate the height H₂ of the free space 34 within the flooded battery 22.

The inner diameters D₁, D₂ of the lower and upper ends 18, 16, respectively, of the internal vent well 12 are selected such that a nozzle 36 of a fill gun 38 may be accepted within the internal vent well 12. As will be described in detail below, an end 40 of the fill gun nozzle 36 may be prevented from extending past the lower end 18 of the inner vent well 12. Thus, the end 40 of the fill gun nozzle 36 may be approximately positioned at the recommended height H₂ of the free space 34.

Referring still to FIG. 3, when the fill gun 38 is an automatic fill gun, back pressure will begin to build within the fill gun 38 when dispensing water into the battery 22 as the upper surface 30 of the electrolyte solution 28 rises and approaches the end 40 of the nozzle 36. When the upper surface 30 of the electrolyte solution 28 reaches the lower end 18 of the internal vent well 12, the back pressure in the fill gun 38 may build to the point where the fill gun 38 automatically shuts off. Thus, the electrolyte level 30 is filled to the proper height H₁ above the electrodes 26 without underfilling or overfilling the flooded battery 22.

In one embodiment intended for use with an automatic fill gun 38, side walls of the internal vent well 12 are continuous without any openings, save for the upper and lower openings 17, 19 at the upper and lower ends 16, 18 of the internal vent well 12. The continuous walls of the internal vent well 12 allow a build up of pressure when the electrolyte solution level 30 reaches the lower end 18 of the internal vent well 12. This pressure build up is sensed by the automatic fill gun 38 and causes the flow of water to be stopped automatically.

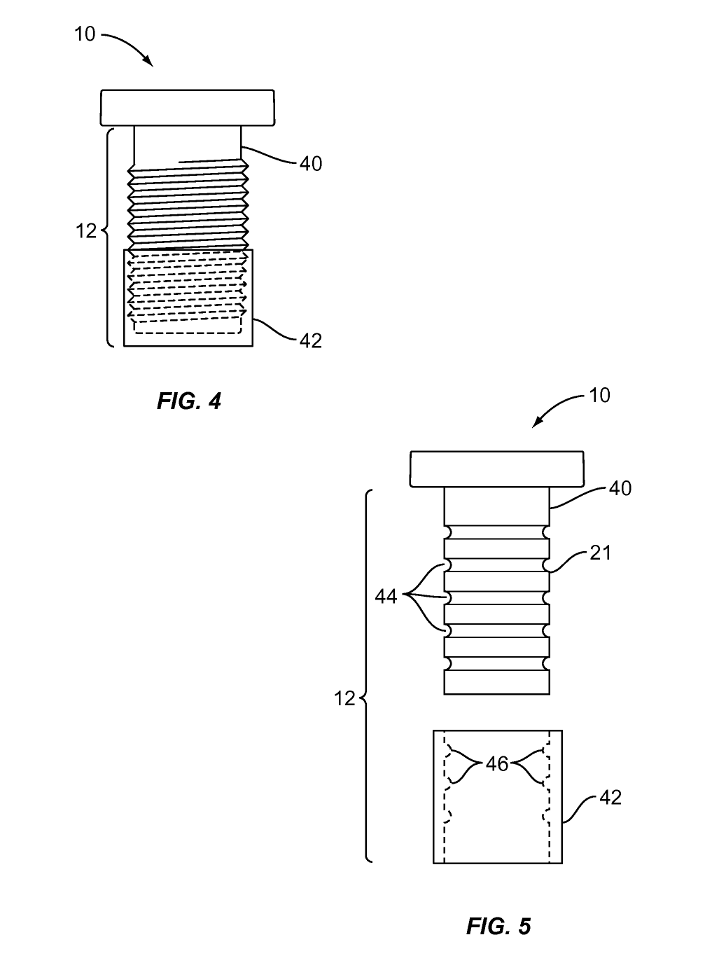

As is apparent in the embodiment illustrated in FIG. 3, the length L₁ of the inner vent well 12 determines the height H₂ of the free space 34 when an automatic fill gun 38 is used to add water to the flooded battery 22. The length L₁ of the internal vent well 12 may be fixed; that is, the internal vent well is constructed of a hollow, cylindrical tube with solid, continuous side walls. In other embodiments, the length L₁ of the internal vent well 12 may be variable or adjustable using any type of construction know in the art. By way of non-limiting example, FIG. 4 illustrates an internal vent well 12 comprised of a first section 40 and a second section 42 that threadably engage one another. By varying the amount that the first and second sections 40, 42 are threadably engaged, a variety of internal vent well lengths L₁ may be obtained. One embodiment may also include a locking ring (not shown) to lock the first and second sections 40, 42 at a selected position to provide a desired length L₁. Although FIG. 4 illustrates that the first section 40 is a male component and the second section is a female component, this arrangement could also be reversed.

FIG. 5 illustrates another non-limiting embodiment of an adjustable length L₁ internal vent well 12. In this embodiment, the first section 40 comprises a plurality of partially or fully circumferential grooves or indentations 44 on an outer surface 21 of the first section 40 of the internal vent well 12. The second section 42 comprises one or more corresponding detents that engage one or more of the grooves 44. The desired length L₁ of the internal vent well 12 may be obtained by sliding the first and second sections 40, 42 together until the detents 46 engage the indentations 44 at the desired length L₁. Although FIG. 5 illustrates that the indentations 44 are on the first section 40 and the detents 46 are on the second section 42, the opposite arrangement is also possible.

One embodiment of the present invention comprises an insertion depth limiter 41 for restricting how far the nozzle 36 of the fill gun 38 may be inserted into the internal vent well 12. As illustrated in FIG. 6, one embodiment of the insertion depth limiter 41 comprises a first crossbar 48 and a second crossbar 50 positioned in proximity to the lower end 18 of the internal vent well 12 and spanning the lower opening 17. Although illustrated as being positioned approximately normal to one another, the first and second crossbars 48, 50 may intersect each other at angles other than 90 degrees. In one embodiment, the first and second crossbars 48, 50 do not intersect one another. Another embodiment comprises the first crossbar 48, but not the second crossbar 50.

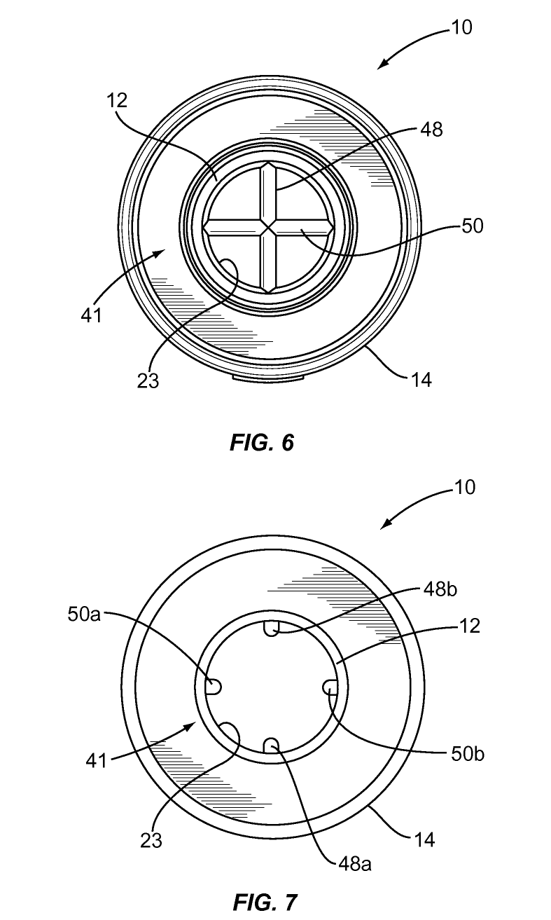

While FIG. 6 illustrates the first and second crossbars 48, 50 extending completely across the lower opening 17, one embodiment illustrated in FIG. 7 comprises crossbars that do not span the lower opening 17. For example, first crossbar sections 48a, 48b extend outward from an inner surface 23 of the internal vent well 12, but may not extend completely across the lower opening 17. Other embodiments may include a single crossbar section 48a, while still other embodiments include a plurality.

FIG. 7 illustrates an embodiment of the insertion depth limiter 41 comprising a screen 52. The screen 52 may extend across all or a portion of the lower opening 17.

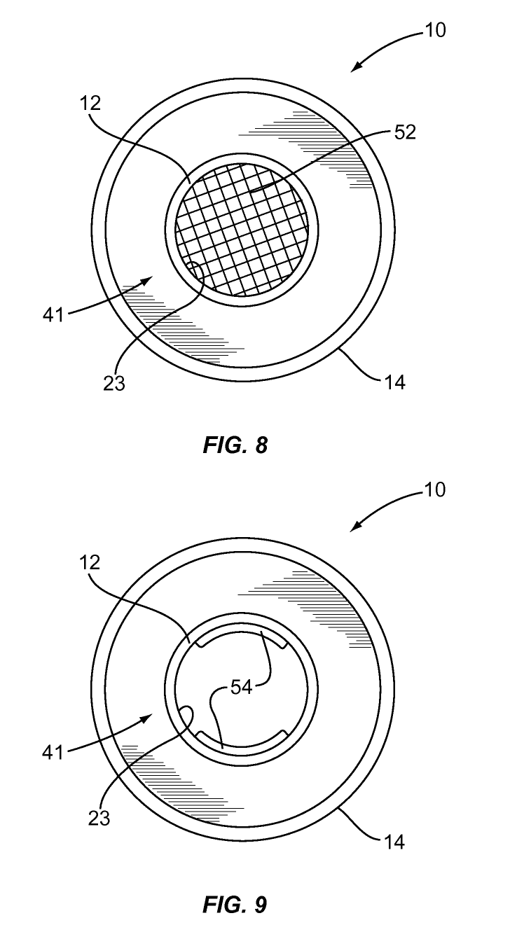

FIG. 9 illustrates an embodiment of the insertion depth limiter 41 comprising one or more ridges 54 extending around at least a portion of the circumference of the inner surface 23 of the internal vent well 12. In one embodiment, multiple ridges 54 are positioned around the circumference of the inner surface 23 of the internal vent well 12. In one embodiment, a single ridge 54 is positioned around at least a portion of the circumference of the inner surface 23 of the internal vent well 12.

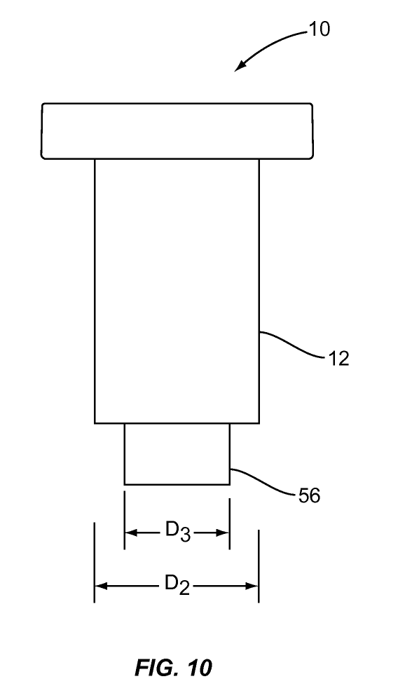

One embodiment of the insertion depth limiter 41 as illustrated in FIG. 10 comprises a reduced diameter portion 56 of the internal vent well 12. A diameter D₃ of the reduced diameter portion 56 may be less than the inner diameter D₂ of the internal vent well 12. The diameter D₃ of the reduced diameter portion 56 may be less than an outer diameter D₄ (see FIG. 3) of the nozzle 36 such that the nozzle 36 may not be inserted into the internal vent well 12 further than the reduced diameter portion 56.

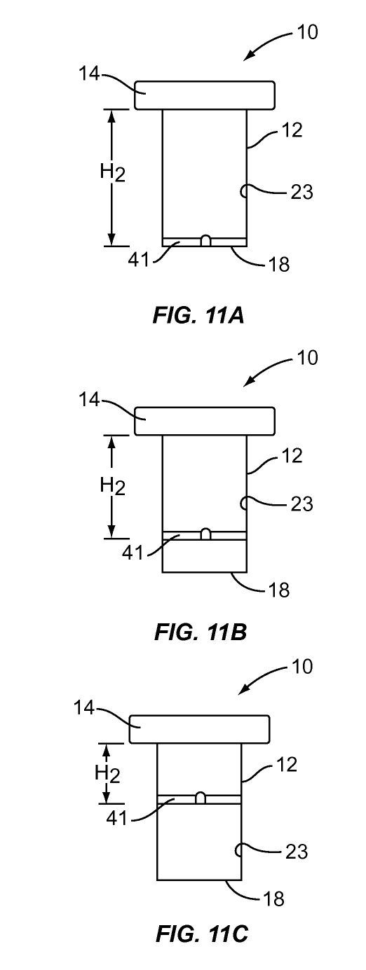

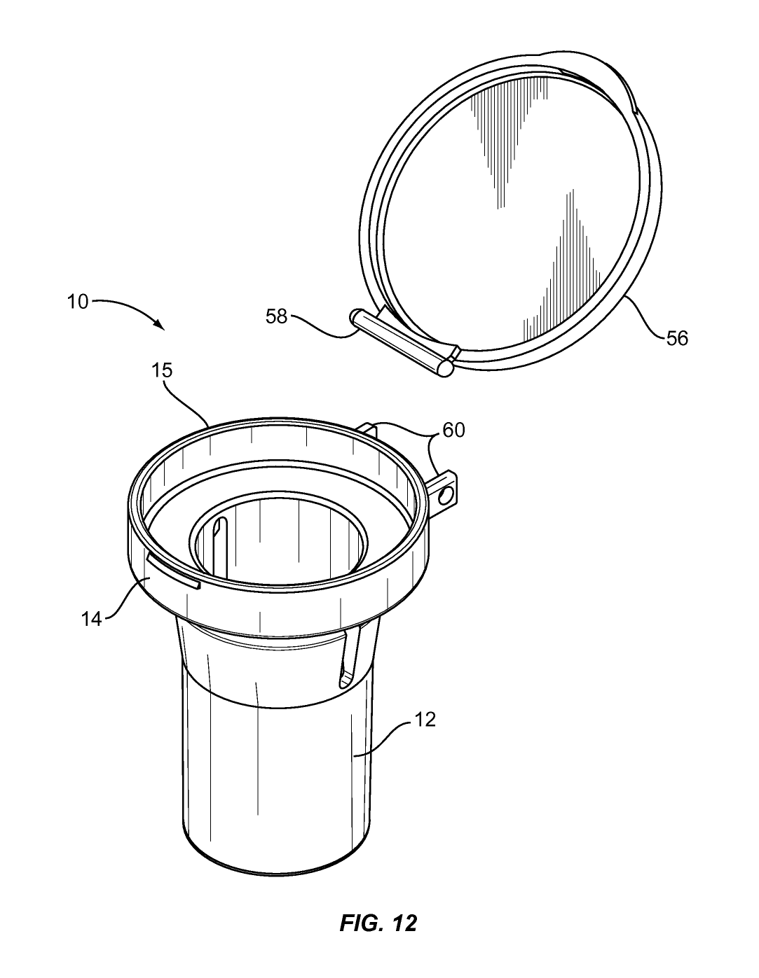

Additionally, the insertion depth limiter 41 may be positioned at any point along the length L₁ of the internal vent well 12. FIG. 11A illustrates the insertion depth limiter 41 positioned in proximity to the lower end 18 of the internal vent well 12. FIGS. 11B and 11C illustrate the insertion depth limiter 41 positioned a variety of distances apart from the lower end 18. The position of the insertion depth limiter 41 along the length L₁ of the internal vent well 12 may determine the height H₂ of the free space when an automatic fill gun 38 is used. Thus, in one embodiment the insertion depth limiter 41 may be positioned approximately ⅛ inch to approximately 1 inch from the upper end 16 of the internal vent well 12.

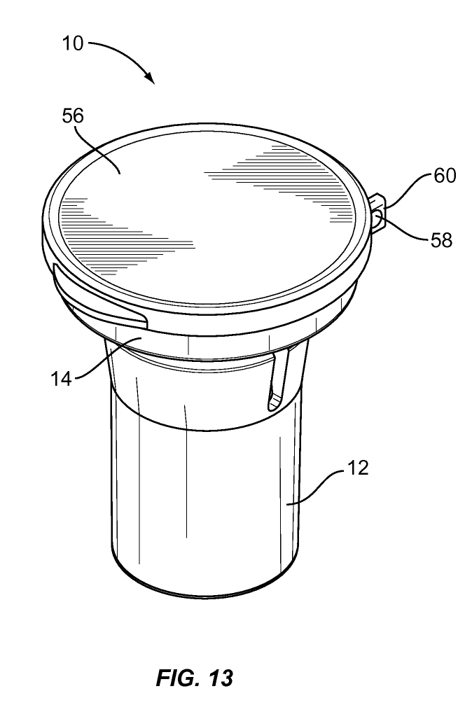

FIG. 12 illustrates one embodiment of the vent cap 10 comprising a cover 56 that releasable attaches over an upper edge 15 of the external mounting flange 14. FIG. 13 illustrates the cover 56 in a closed position over the external mounting flange 14 to prevent spillage of the electrolyte solution 28. In one embodiment, a hinge pin 58 is secured in proximity to an outer edge of the cover 56. The hinge pin 58 is adapted to engage one or more hinge brackets 60 mounted on an outer surface of the external mounting flange 14 to hingedly attach the cover 56 to the vent cap 10. Any hinge mechanism known in the art may be used to attach the cover 56 to the vent cap 10. Alternatively, in one embodiment there is no hinge mechanism. A pressure relief vent (not shown) may be included in the cover 56 of one embodiment to allow gases that build up within the flooded battery 22 to escape.

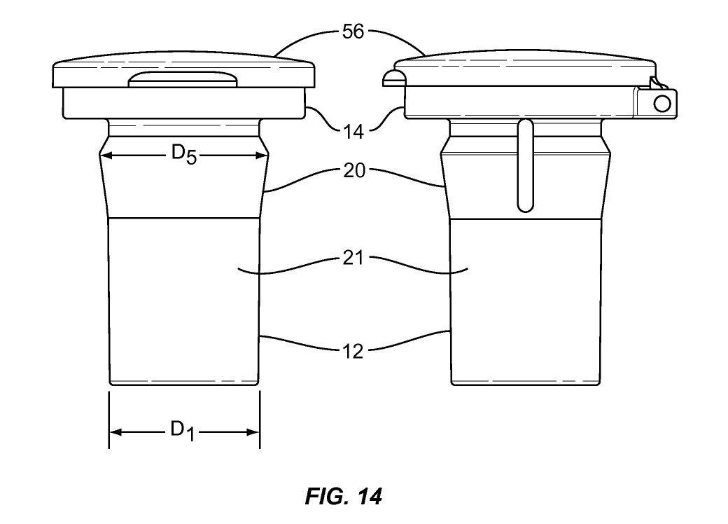

In one embodiment, the vent cap 10 is adapted for a press fit attachment to the flooded battery 22. As illustrated in FIG. 14, the outer surface 21 of the internal vent well 12 may include a shoulder 20. An outer diameter D₅ of the shoulder 20 may be greater than diameter D₁ or diameter D₂ of the internal vent well 12. Additionally, the outer diameter D₅ of the shoulder may be greater than a diameter of the battery vent opening 24 such that the shoulder 20 frictionally engages the battery vent opening 24. One embodiment of the shoulder 20 comprises one or more expansion joints 62 to allow some amount of compression of the shoulder 20 when the vent cap 10 is press fit into the battery vent opening 24.

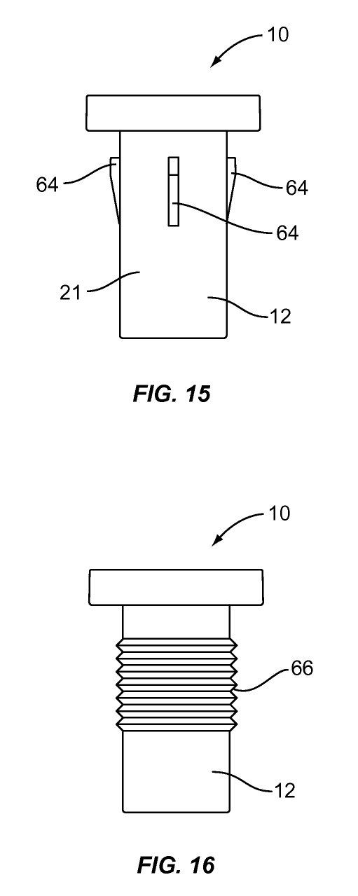

Mechanisms other than the shoulder 20 to affect a frictional engagement between the vent cap 10 and the battery vent opening 24 are also within the scope of the present invention. FIG. 15 illustrates one embodiment comprising one or more ribs 64 arranged on the outer surface 21 of the internal vent well 12. FIG. 16 illustrates one embodiment in which the outer surface 21 of the internal vent well 12 includes threads 66 adapted to engage corresponding threads (not shown) on the battery vent opening 24.

While the embodiments illustrated above describe the internal vent well 12 as comprising a generally cylindrical cross-sectional shape, other polygonal shapes are also within the scope of the present invention. For example, the cross-sectional shape of the internal vent 12 well may be triangular, quadrilateral, pentagonal, ovoid, etc. Additionally, the above embodiments illustrate a single vent cap 10. In one embodiment, multiple vent caps 10 may be connected together to form a single device.

Spatially relative terms such as “under”, “below”, “lower”, “over”, “upper”, and the like, are used for ease of description to explain the positioning of one element relative to a second element. These terms are intended to encompass different orientations of the device in addition to different orientations than those depicted in the figures. Further, terms such as “first”, “second”, and the like, are also used to describe various elements, regions, sections, etc. and are also not intended to be limiting. Like terms refer to like elements throughout the description.

As used herein, the terms “having”, “containing”, “including”, “comprising”, and the like are open ended terms that indicate the presence of stated elements or features, but do not preclude additional elements or features. The articles “a”, “an” and “the” are intended to include the plural as well as the singular, unless the context clearly indicates otherwise.

The present invention may be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A flooded battery vent cap for insertion into a flooded battery vent opening, comprising:
an internal vent well having a lower end and an upper end opposite the lower end, and further comprising an outer diameter adapted for insertion into the flooded battery vent opening, an internal diameter defining a hollow space adapted to receive a watering gun nozzle therein, and a watering gun nozzle insertion depth limiter positioned within the internal vent well; and
an external mounting flange attached to the upper end of the internal vent well, wherein an outer diameter of the external mounting flange is greater than the outer diameter of the internal vent well.

2. The flooded battery vent cap of claim 1, wherein the internal vent well comprises an essentially cylindrical tube having continuous side walls at all points extending from the upper end to the lower end.

3. The flooded battery vent cap of claim 1, wherein the insertion depth limiter comprises a ridge extending circumferentially at least partially around an inner surface of the internal vent well.

4. The flooded battery vent cap of claim 3, wherein the ridge defines a reduced diameter less than the inner diameter of the internal vent well.

5. The flooded battery vent cap of claim 1, wherein the insertion depth limiter comprises at least one bar extending across the hollow space of the internal vent well.

6. The flooded battery vent cap of claim 1, wherein the insertion depth limiter comprises at least one protrusion extending from an inner surface of the internal vent well into the hollow space.

7. The flooded battery vent cap of claim 6, further comprising at least two protrusions, the ends of which define a generally circular shape having a diameter less than the inner diameter of the internal vent well.

8. The flooded battery vent cap of claim 1, wherein the insertion depth limiter is positioned in proximity to the lower end of the internal vent well.

9. The flooded battery vent cap of claim 1, wherein the insertion depth limiter is positioned about ⅛ inch to about 1 inch from the upper end of the internal vent well.

10. A flooded battery vent cap for insertion into a flooded battery vent opening, comprising:
a cylindrical tube defining a hollow space adapted to receive a nozzle of a water filling gun therein, the cylindrical tube having an outer diameter adapted for insertion into the flooded battery vent opening;
a mounting flange attached to a first end of the cylindrical tube, wherein an outer diameter of the external mounting flange is greater than the outer diameter of the cylindrical tube; and
a watering gun nozzle insertion depth limiter positioned proximate to a second end of the cylindrical tube, wherein the second end is opposite the first end;
wherein when the flooded battery vent cap is positioned in the flooded battery vent opening, the cylindrical tube is positioned primarily within the flooded battery and the mounting flange is positioned primarily outside the flooded battery;
wherein the insertion depth limiter is positioned about ⅛ inch to about 1 inch from the first end of the cylindrical tube.

11. The flooded battery vent cap of claim 10, wherein the cylindrical tube further comprises an annular shoulder portion in proximity to the first end adapted to frictionally engage an inner circumference of the flooded battery vent opening.

12. The flooded battery vent cap of claim 10, wherein the cylindrical tube further comprises a plurality of longitudinally arranged ribs adapted to frictionally engage at least a portion of an inner circumference of the flooded battery vent opening.

13. The flooded battery vent cap of claim 10, wherein the cylindrical tube further comprises screw threads on an outer surface of the cylindrical tube.

14. A flooded battery vent cap for insertion into a flooded battery vent opening, comprising:
an internal vent well comprising a first section and a second section, each of the first and second sections having an engagement end and a non-engagement end opposite the engagement end; wherein the engagement ends of the first and second sections are adapted to be movably positioned at least partially one within the other such that any of a variety of predetermined lengths of the internal vent well may be selected;
a mounting flange attached to the non-engagement end of the first section of the internal vent well, wherein an outer diameter of the external mounting flange is greater than an outer diameter of the first section; and
a watering gun nozzle insertion depth limiter positioned proximate to the non-engagement end of the second section of the internal vent well;

15. The flooded battery vent cap of claim 14, wherein when the first and second sections are positioned at least partially one within the other, the insertion depth limiter is positioned about ⅛ inch to about 1 inch from the non-engagement end of the first section.

16. The flooded battery vent cap of claim 14, further comprising a cover hingedly attached to the mounting flange.

17. The flooded battery vent cap of claim 16, further comprising a pressure relief vent in the cover.

18. The flooded battery vent cap of claim 14, wherein the first and second sections are movably positioned at least partially one within the other using a threaded connection.

19. The flooded battery vent cap of claim 14, wherein the first and second sections are movably positioned at least partially one within the other using a plurality of ridges positioned circumferentially on one or both of the first and second sections.

20. The flooded battery vent cap of claim 14, wherein the first section further comprises an annular shoulder portion in proximity to the non-engagement end adapted to frictionally engage an inner circumference of the flooded battery vent opening.
